(19) United States
(12) Patent Application Publication
(10) Pub. No.: US 2025/0307534 A1
(43) Pub. Date: Oct. 2, 2025

(54) Interactive graph companion table for enhanced data visualization and analysis

(71) Applicant: Minhong Mi, Newton, MA (US)

(72) Inventor: Minhong Mi, Newton, MA (US)

(21) Appl. No.: 18/622,886

(22) Filed: Mar. 30, 2024

(51) Int. Cl. G06F 40/18; G06F 16/26; G06F 40/106

(52) U.S. Cl. CPC G06F 40/18; G06F 16/26; G06F 40/106

(57) ABSTRACT

Methods and system are disclosed to implement an interactive companion table alongside graphical data visualizations within a computing environment, aimed at enriching data analysis and interpretation. The underlying numerical data of the graphs are displayed through a specialized table and responses to user interactions between the graphs and the table are highly synchronized with the establishment of the bidirectional links between each graph and its corresponding cells in the table. The method encompasses several key procedures: initializing a table object, accessing graphs in the active data visualization, incorporating cell blocks to represent data elements of graphs, adding bidirectional links, refreshing the table display, and handling user interactions. The methods and system enhance the data analysis experience by closely integrating visual and numerical information and is especially useful in areas that demand an in-depth examination of data alongside a broad visualization, including financial analysis, scientific research, and business intelligence.

### TECHNICAL FIELD

This relates in general to the field of electric data processing, and more specifically to data visualization.

### BACKGROUND

In the domain of data visualization, the transformation of datasets into graphical representations such as dots, lines, and surfaces serves a crucial role in visually communicating quantitative messages. These graphical displays are instrumental in unveiling the relationships within the underlying data, thereby rendering complex datasets more comprehensible. Despite these advantages, tables, with their ability to present exact numerical values of data items, remain a preferred method for detailed examination of data. This preference underscores the inherent limitation in most established data visualization applications, where the data values mapped to graphical elements are not immediately visible. This issue is particularly pronounced when the transformation from raw data to graphical displays involves multiple steps, complicating the process for users who need to inspect precise numerical values within a visualization, such as item counts in a histogram graph. Such users are often compelled to manually create a separate table for this purpose and subsequently delete it once they no longer need to view the numerical data, provided their primary interest lies in the graphical representation alone.

Moreover, while generic tables display numerical values in structured rows and columns, the design of a table specifically tailored to complement graphical data visualizations opens avenues for significant customization and enhanced coordination between the graphical elements and the tabular data. This approach not only addresses the gap in accessing precise numerical values directly from graphical representations but also offers a more integrated and seamless experience in data analysis. By focusing on the design and implementation of tables that are specifically engineered to display underlying data contents of visualizations, there exists a potential to significantly enhance the utility and efficiency of data visualization tools, thereby facilitating a more comprehensive and intuitive analysis process for users.

### SUMMARY

The described embodiment constitutes a method and system for an interactive companion table implementation alongside graphical data visualization within a computing environment, aimed at enriching data analysis and interpretation. This innovative approach presents the underlying numerical data of the graphical visualizations through a specialized table, ensuring a highly synchronized response to user interactions. The method encompasses several key procedures: identifying the active graphical visualization, accessing and analyzing the graphs, incorporating cell blocks to represent data elements of graphs, adding bidirectional links, and handling user interactions with the graphs and the table. A critical feature of this method is the establishment of the bidirectional links between each graph and its corresponding cells in the table, enabling real-time detection and propagation of user interactions across the graphical and numerical data representations. This technique fosters a more interactive and comprehensive data analysis experience by tightly coupling visual and quantitative information, making it highly applicable in fields requiring detailed data scrutiny alongside overview visualization, such as financial analysis, scientific research, and business intelligence.

The summary is provided to introduce a selection of concepts in a simplified form and thus not intended to identify key features or essential features of the claimed subject matter, nor is it intended to be used to limit the scope of the claimed subject matter.

### BRIEF DESCRIPTION OF THE DRAWINGS

FIG. 1 is an illustration of the hierarchical structure of data visualizations in which various embodiments may be practiced;

FIG. 2A is a screenshot showing the first sheet of an exemplary two-sheet data visualization according to the invention;

FIG. 2B is a screenshot showing the second sheet of an exemplary two-sheet data visualization according to the invention;

FIG. 3 is a screenshot of a single sheet data visualization of a line graph and a column graph and a Graph Companion Table according to the invention;

FIG. 4 is a screenshot of a single sheet data visualization of two graphs with different X coordinates and a Graph Companion Table according to the invention;

FIG. 5 is a screenshot of a single sheet data visualization of a surface graph and a Graph Companion Table according to the invention;

FIG. 6 is a screenshot of a single sheet data visualization of a contour graph and a Graph Companion Table according to the invention;

FIG. 7A is a screenshot of a single sheet data visualization of a column graph in which various embodiments may be practiced;

FIG. 7B is a screenshot of the default view of a Graph Companion Table according to the invention for the column graph shown in FIG. 6A;

FIG. 7C is a screenshot of the alternative view of a Graph Companion Table according to the invention for the column graph shown in FIG. 6A;

FIG. 8 is a screenshot of a single sheet data visualization of two line graphs with multiple data point selected and a Graph Companion Table according to the invention;

FIG. 9 is a screenshot of a single sheet data visualization of two line graphs with two data markers and a Graph Companion Table according to the invention;

FIG. 10 illustrates a computing system in which the methodologies in accordance with the present invention may operate;

FIG. 11 is a flowchart illustrating the code execution path of the Graph Companion Table according to the invention; and

FIG. 12 is a simplified diagram illustrating the bidirectional links between the graphs shown in FIG. 3 and cell blocks in the Graph Companion Table according to the invention.

### DETAILED DESCRIPTION

In the realm of data analysis, the practice of data visualization emerges as a cornerstone, transforming numerical data with dots, lines, and surfaces into a visual format that conveys quantitative messages. This pivotal technique facilitates the user's ability to analyze, reason, and derive insights from data, thereby rendering intricate datasets more comprehensible, accessible, and amenable to practical application. The present invention seeks to enhance this fundamental step in data analysis by introducing an innovative approach to data visualization.

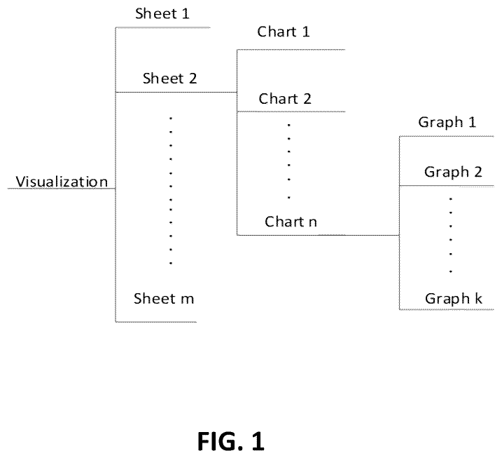

A data visualization according to the invention is preferably structured hierarchically, using visualization elements including, in the descending order, sheets, charts, and graphs as illustrated in FIG. 1. At the base of this hierarchy lies the graph, which, despite being the most fundamental element, plays a crucial role in summarizing a dataset and effectively communicating its significance to the user. They are used for illustrating comparisons, trends, and data relationships through a broad array of predefined types such as scatter plots, line graphs, stem graphs, bar graphs (whether single, stacked, or clustered), surface graphs, matrix plots, and heatmap graphs. Charts serve to aggregate related graphs, ensuring that all graphs within a chart are unified by common axes. This means any adjustment to a chart's axis automatically updates all associated graphs, maintaining coherence across the visualization. Sheets serve as the foundation for these visual elements, often organizing multiple charts into a structured layout, such as a grid, although charts can also vary in size and position as the visualization requires. In specific applications, like spreadsheet programs, sheets primarily function to display cells and tables, with charts superimposed on this foundational layer.

There is no limit to the number of visualization elements which may be included in any given level of hierarchy. Specifically, a visualization can encompass an unlimited number of sheets; similarly, each sheet can contain an indefinite number of charts, and each chart can host a myriad of graph combinations.

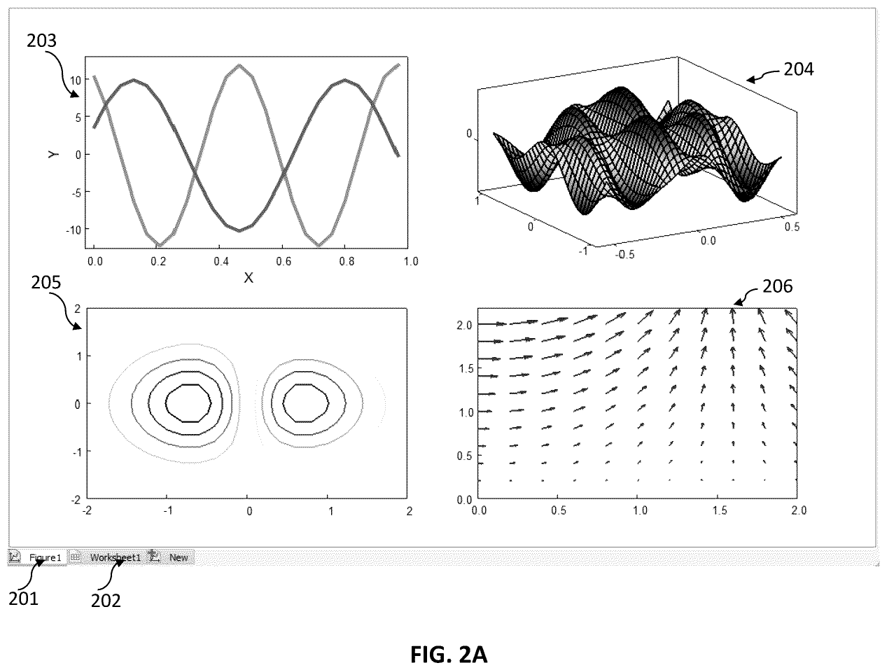

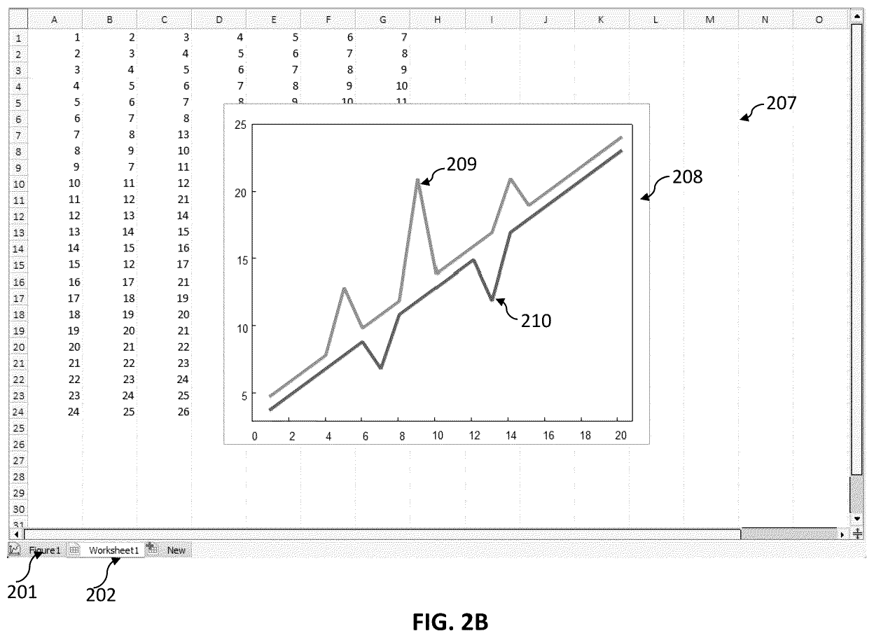

An example of data visualization is depicted in FIG. 2, showcasing two sheets housed in tabs labeled ‘Figure1’ (201) and ‘Worksheet1’ (202) respectively. FIG. 2A shows the content of sheet 201, which includes four distinct charts laid out in a two-row-by-two-column grid. Each chart in the sheet contains different types of graphs: a chart 203 with two line graphs, a chart 204 featuring a surface graph, a chart 205 with a contour graph, and a chart 206 with an arrow (vector) graph. FIG. 2B illustrates the other sheet 202 of a spreadsheet 207 embedded with a chart 208 that houses two line graphs 209 and 210.

The invention introduces the ‘Graph Companion Table,’ an innovative tool for data presentation, crafted to complement and enhance graphical data visualizations by showcasing the numerical values of the underlying data in a structured, spreadsheet-like tabular format. In a preferred implementation of this invention, the Graph Companion Table dynamically aligns its content with that of the currently active chart within the visualization framework. An ‘active chart’ is identified here as either the last chart with which a user has interacted or the most recently created chart in scenarios devoid of user interaction. For example, when a user is working with chart 208 inside the spreadsheet 202 shown in FIG. 2B, chart 208 is the active chart and the Graph Companion Table shows the X and Y values for the two line graphs in chart 208. Later, if the user switches to tab 201 and clicks on chart 204 inside the sheet, the active chart becomes chart 204 and the content of the Graph Companion Table is automatically updated to show the X, Y, and Z coordinates of the surface graph inside chart 204.

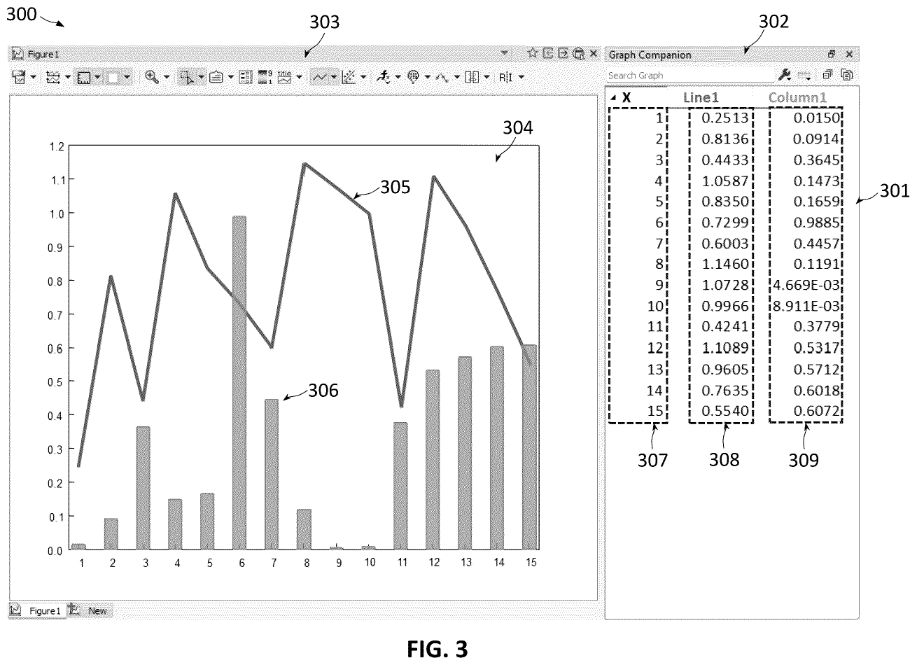

FIG. 3 illustrates an embodiment 300 of a software application featuring a Graph Companion Table 301, housed within a widget 302. The data visualization sheet 303 with a single chart 304 includes a line graph 305 and a column graph 306. It is understood that this configuration, with the widget docked to the right of the main visualization area, is provided as an illustrative example. The positioning of the widget, and thereby the Graph Companion Table, is not restricted to this arrangement. Additionally, the integration of the Graph Companion Table within the software application is not limited to its encapsulation within a distinct widget. Alternative embodiments may incorporate the Graph Companion Table directly within the visualization sheet, making it a direct component of the data visualization interface.

The display area inside Graph Companion Table 301 in FIG. 3 is structured with various cell blocks, which are rectangular regions encompassing one or more cells that serve same or similar purposes in presenting the numerical values related to the graphs. For example, cell block 307, consisting of numerical cells in the first column, presents the X-coordinate values that are common across both depicted graphs while cell blocks 308 and 309, consisting of numerical cells in columns 2 and 3, enumerate the Y-coordinate values associated with graphs 305 and 306, respectively. The program stores pertinent information about the linked graphs for each cell block, fetches or derives the data required for rendering each cell from the graphs and provides it to the application platform whenever a refresh of the table display is in order.

This embodiment illustrated in FIG. 3 showcases a columnar layout for data values, yet it's crucial to recognize the design's flexibility, allowing alternative embodiments to adopt a row-based layout. In such configurations, each row would represent a different line graph within the visualization. Although the current example features two graphs, it is merely illustrative; the design accommodates a varying count of graphs, influencing the corresponding adjustment in the number of columns or rows within the Graph Companion Table.

In FIG. 3, while line and column graphs are utilized the Graph Companion Table is designed to support an extensive range of graphical representations, including, but not limited to, surfaces, contours, arrows, points, and various other data visualization techniques. It intuitively selects a presentation format that maximizes clarity and ease of understanding for users when it comes to revealing the underlying data of graphs based on their types and nature. Specifically, for a two-dimensional graph like lines line, column, bar, and area, data is organized into a single row or column within the Graph Companion Table. In instances where multiple two-dimensional graphs are present in the same chart, these graphs may be grouped together, sharing a common row or column for X coordinates while allocating individual rows or columns for the Y coordinate values of each graph's source data.

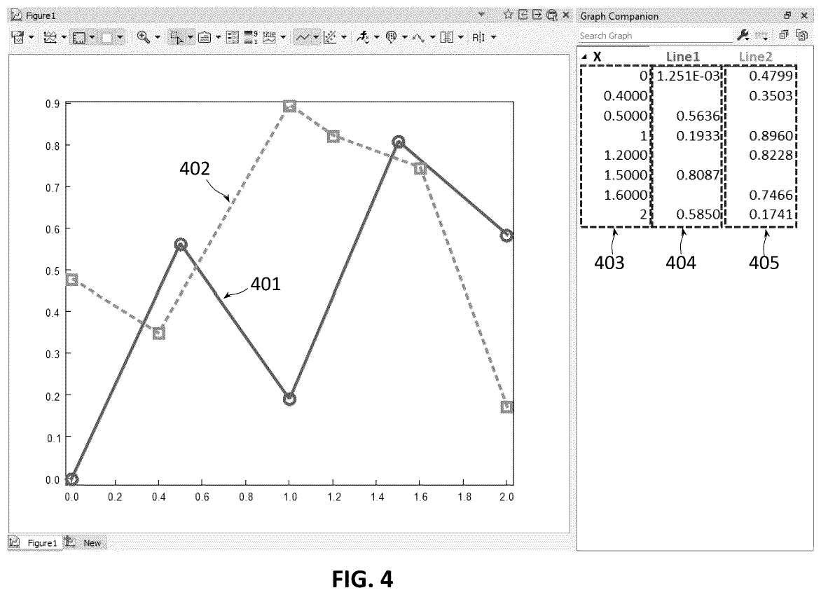

For scenarios involving graphs with disparate X-axis coordinates, the system ingeniously amalgamates all X-axis values into a unified X coordinate row or column. This inclusive approach ensures even X-axis values absent in certain graphs are accounted for, thereby leaving corresponding cells in the Y-value rows or columns vacant. This strategic layout simplifies direct comparisons across varied datasets by addressing and visually indicating discrepancies in X-axis coordinates. FIG. 4 exemplifies this methodology through the depiction of two line graphs, ‘Line1’ (401) and ‘Line2’ (402), possessing different X-axis coordinates. Here, the comprehensive aggregation of X-axis values is displayed in cell block 403, with Y-axis values of ‘Line1’ and ‘Line2’ represented in cell blocks 404 and 405, respectively. Notably, due to the absence of data points for ‘Line1’ at X-axis values of 0.4, 1.2, and 1.6, the corresponding cells within cell block 404 are intentionally left blank. A similar principle applies to ‘Line2’ in cell block 405, where cells representing X-axis values of 0.5 and 1.5 remain empty to indicate the non-existence of data points at these coordinates for ‘Line2’.

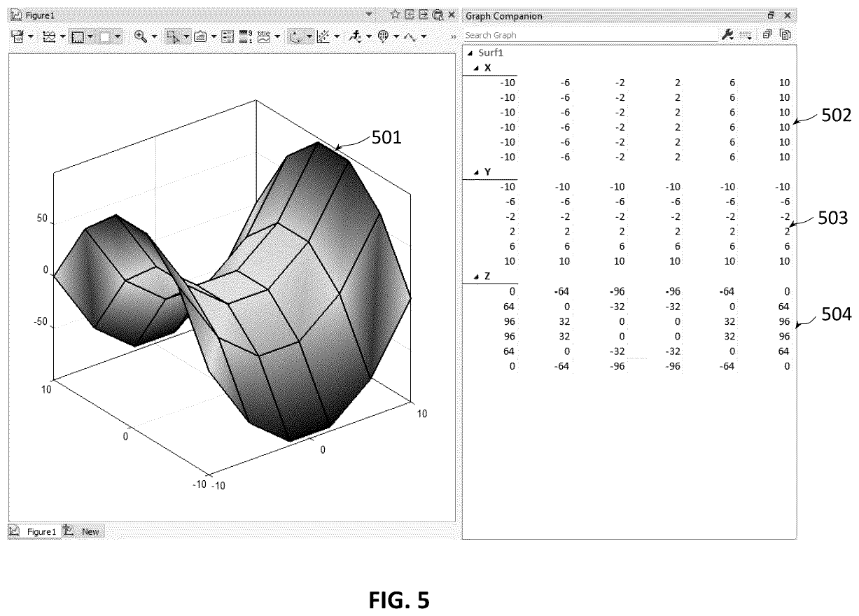

For visualizations that extend into three dimensions, such as surfaces, meshes, volume, and vector graphs, the program delineates data by displaying X, Y, and Z coordinates in distinct cell blocks. This setup also includes any available information regarding graph attributes like color and alpha. An illustrative example of this arrangement for a surface plot is provided in FIG. 5 where the X, Y, and Z coordinates of a surface graph 501 are tabulated in cell blocks 502, 503, and 504 respectively.

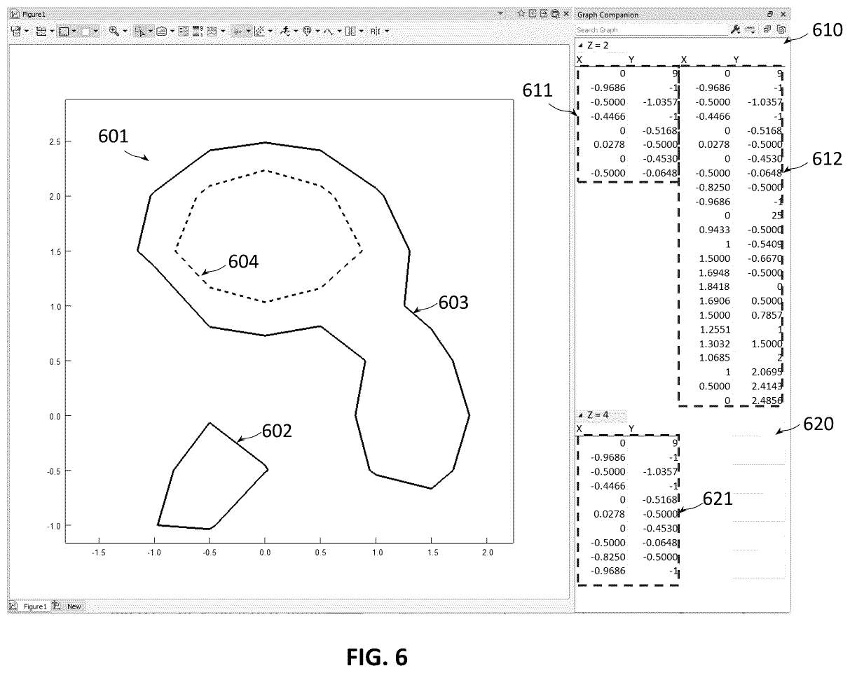

For contour graphs, an innovative segmented data presentation strategy is employed, utilizing a sequence of data tables, each dedicated to encapsulating the entire set of contour coordinates for a distinct contouring level. This method systematically organizes the coordinates for contour lines within these tables into pairs of rows or columns. Each pair is meticulously designed to correspond to a singular contour line, significantly enhancing the efficiency and clarity of contour data visualization across assorted levels. Illustratively, FIG. 6 showcases an optimized configuration for a contour graph 601 featuring two distinct contouring levels at Z=2 and Z=4. Within this setup, data table 610 is segmented into two cell blocks 611 and 612, each precisely displaying the coordinates for the contour lines 602 and 603 at the Z=2 contouring level. Conversely, data table 620 is streamlined to include a singular cell block 621, dedicated to presenting the coordinates for the sole contour line 604 identified at the Z=4 level. This structured presentation not only facilitates an immediate and intuitive understanding of the contour lines at each level but also allows for a seamless comparison and analysis of contour data across different contouring levels.

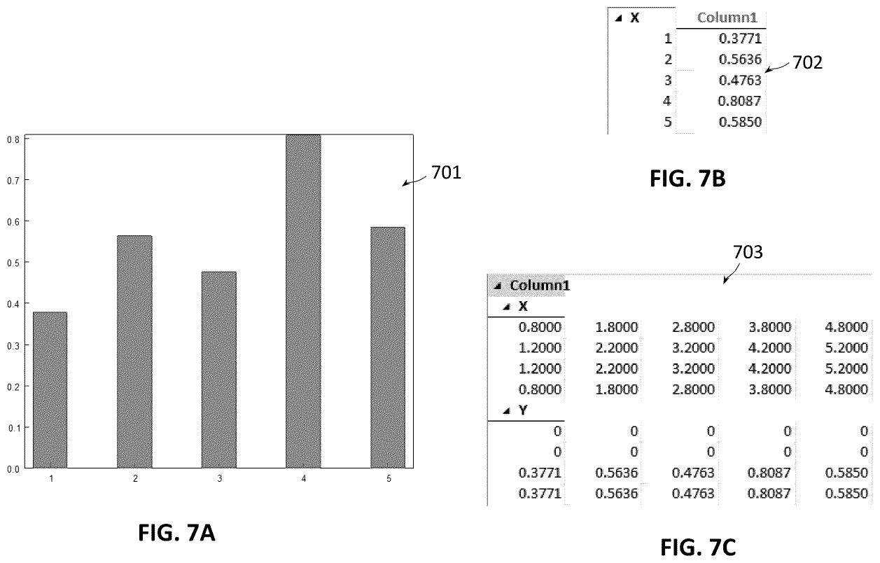

In a preferred implementation of the invention, the Graph Companion Table, by default, displays the original data set from which a graph is derived, populating its cell blocks with this source data. However, it also offers the flexibility to present data corresponding to the geometric shapes comprising the graph. For instance, the default configuration for a basic column graph 701 as illustrated in FIG. 7A, which visually represents five data points as five rectangles, is to display source X and Y values in the Graph Companion Table 702, as shown in FIG. 7B. However, users have the option to switch to an alternative display in the Graph Companion Table that shows the X and Y coordinates of the four vertices of each rectangle in matrix form as illustrated in FIG. 7C. In this view, each pair of X and Y columns in table 703 maps to the coordinates of the four vertices of one rectangle in the graph 701, which in turn represents a single data point from table 702. This alternative approach to data presentation allows users to interact with the vertices of the geometric shapes on the graph, either through the Graph Companion Table or directly within the graph on the active chart, offering enhanced control over the graph's visualization.

The configurations for organizing cell blocks within the Graph Companion Table, as previously outlined, serve as illustrative examples, and are not intended to be limiting. The Graph Companion Table can adopt a variety of layouts, each tailored to optimally complement the currently displayed data visualization. While a comprehensive enumeration of all possible layouts is omitted here for conciseness, this omission should not be construed as a limitation on the invention's scope.

Beyond customized layouts, the Graph Companion Table may incorporate additional features to enhance coherence with the graphical displays and user experience. For instance, it can utilize colors that are same or like those of the corresponding graphs for the backgrounds of cells, aiding in the differentiation of data related to multiple graphs within the visualization. Additionally, the implementation of heat maps can be employed, where the background or text color of cells varies in accordance with the numerical values represented by the graphs, further enriching the data analysis experience.

Crucially, the interaction between the user and the Graph Companion Table is highly synchronized with activities performed within the active data visualization. This invention incorporates advanced synchronization features for interactions including but not limited to value editing, data point selection, and data marking, thereby significantly enhancing the user experience and efficacy in data manipulation.

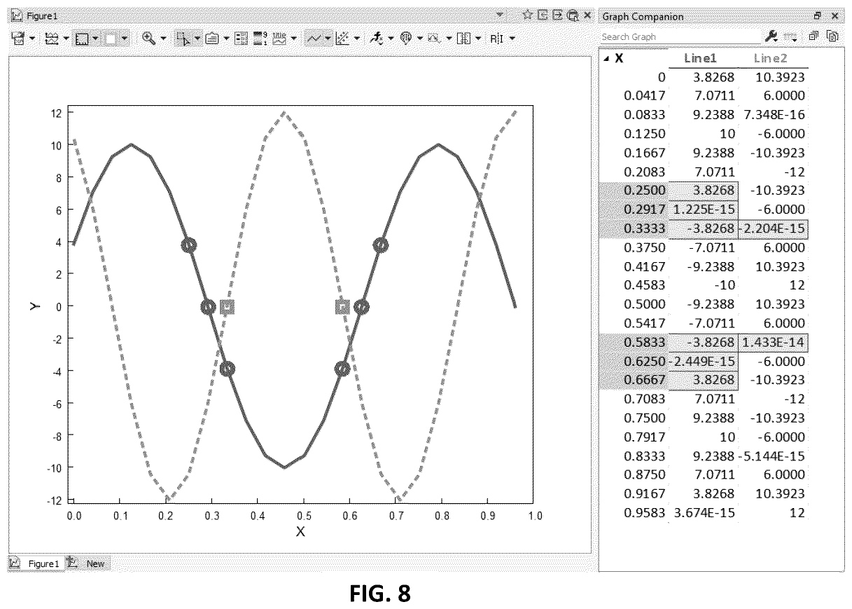

FIG. 8 exemplifies the dynamic synchronization of data selection between the Graph Companion Table and the visualized graphs, where selected data points on the graphs are marked with distinct symbols, and the corresponding table cells are accentuated with thicker borders and a darker background color for easy identification. It's important to understand that the method of distinguishing selected data points depicted in FIG. 8 represents just one of numerous possible approaches. The core concept underpinning this feature is the seamless interaction between the Graph Companion Table and the graphs, a functionality that might not be fully captured through a static image. This synchronization feature ensures that when a user selects data points within the graphical data visualization, whether through direct interaction or via programmatic means, the related cells in the Graph Companion Table are automatically highlighted to reflect this selection. Similarly, selecting cells within the Graph Companion Table triggers the corresponding data points on the visualizations to be highlighted thereby facilitating a bidirectional synchronization that enhances user engagement and data exploration.

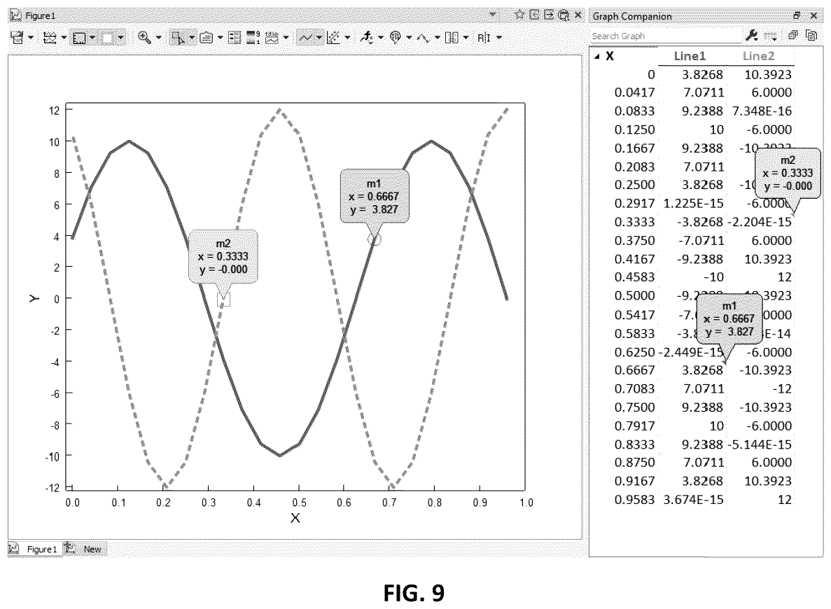

FIG. 9 demonstrates the dynamic synchronization of data markers between the Graph Companion Table and the visualized graphs. Like data point selection, this synchronization process is designed to be agnostic to the origin of the marker's addition; whether a data marker is initially placed on the graphs or entered into the Graph Companion Table, the synchronization mechanism is designed to replicate the marker in the corresponding counterpart nearly instantaneously. If a data marker is relocated within the chart or to a different cell in the Graph Companion Table, the associated data marker in the counterpart is moved to a new location appropriately as well.

Additionally, the Graph Companion Table provides an intuitive interface for modifying the numerical values underlying the graphs, enhancing user interaction with data visualizations. Any adjustments to numerical values within the table are promptly mirrored in the corresponding graphs. Furthermore, this mechanism extends to various other user interactions, including filtering among others. Although it is impractical to list every possible interaction, the descriptions provided are intended to convey the essence of the invention to those well-versed in the field, highlighting its capability to streamline and enrich the data visualization experience through synchronized user interactions.

Having described the visual and functional aspects of the Graph Companion Table. The discussion now turns to the operational mechanics.

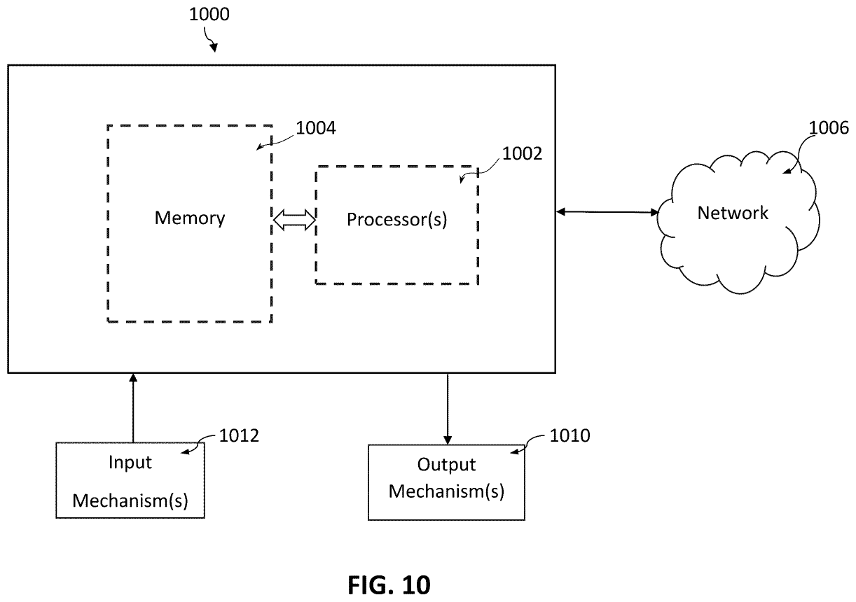

The provision of the graphical user interface for integrated data analysis is facilitated by a computing system 1000 as illustrated in FIG. 10, which is inclusively defined to encompass any device or amalgamation of devices equipped with at least one physical, tangible processor 1002 and a corresponding physical, tangible memory 1004. This memory 1004, capable of storing executable instructions for the processor, may vary in form based on the computing system's design and purpose. Notably, the computing infrastructure can span across networked environments 1006 incorporating multiple interconnected systems. Furthermore, the computing system 1000 may include both output mechanisms 1010 and input mechanisms 1012. Output mechanism 1010 could range from speakers and screens to more advanced options like holograms and virtual reality. Similarly, input mechanisms 1012 may cover a wide spectrum, from microphones and touchscreens to various sensors and physical controls, adapting to the specific needs and functionalities of the computing system.

The methodologies described above are executable across various computing systems, guided by software-driven processes. These processes entail the execution of computer-readable instructions by one or more processors, thereby orchestrating the computing system's operations, including data manipulation. Such instructions are typically housed on computer-readable media, forming the basis of a computer program product.

Experts in the field will recognize the invention's compatibility with a broad spectrum of computing system configurations. These range from personal to mainframe computers, including portable devices, multi-processor systems, consumer electronics, network PCs, and even emerging technologies like wearables. The invention is equally applicable in distributed computing setups, where tasks are allocated across both proximal and distal computing entities interconnected via a mix of wired and wireless networks, with software modules distributed across local and remote storage devices.

Furthermore, the invention is adeptly suited for implementation within cloud computing environments, characterized by the dynamic allocation of computing resources over a network. This model supports various operational characteristics (like on-demand self-service and rapid elasticity) and service models, including SaaS, PaaS, and IaaS, across different deployment models such as private, public, and hybrid clouds. In essence, the description and claims encompass the employment of cloud computing as an integral environment for the invention's application.

The Graph Companion Table can be incorporated in a diverse array of computer program products, including but not limited to spreadsheet applications and specialized data visualization tools. Its utility is exceptionally pronounced in comprehensive integrated environments where the creation of numerous data visualizations from varied data sources is a common practice, facilitated through both textual commands and graphical user interfaces. Serving as a steadfast component within such an environment, the Graph Companion Table offers dynamic content updates to reflect the currently active data visualization. This eliminates the necessity for users to generate a new table each time they wish to explore the underlying numerical values associated with the graphs in their visualizations, thereby streamlining the analytical process and enhancing user efficiency in data analysis tasks.

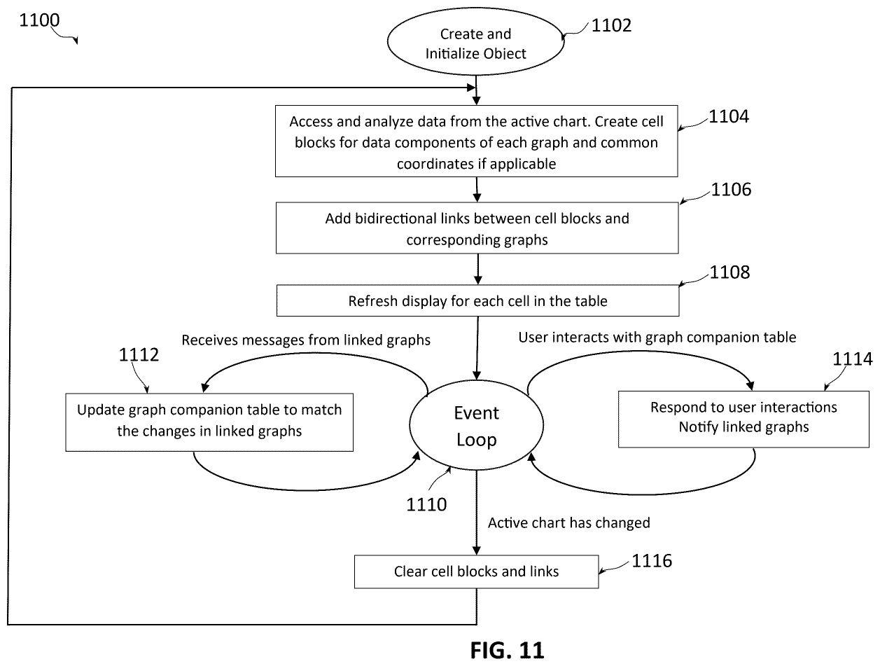

As depicted in the process flowchart 1100 in FIG. 11, the life cycle of a Graph Companion Table commences upon its instantiation within the software application platform. This creation can be triggered either automatically at the software's startup or manually by a user's request during a session. The initial phase, represented by block 1102, involves the creation and initialization of the Graph Companion Table object. Subsequently, the software application assesses the presence of any active data object and, if found, signals the Graph Companion Table of its existence.

Block 1104 generally represents the process of systematically generating cell blocks within the Graph Companion Table for each graph present in the active chart, as well as establishing a shared X-coordinate array when applicable. This is the first among a series of steps required for refreshing the Graph Companion Table's content in response to notifications of active data object changes. These notifications can arise under various circumstances: immediately following the Graph Companion Table's creation, upon the generation of a new data widget, or when a user shifts their focus to a different data containing object within the session.

Specifically in the step represented by block 1104, the program first checks to see if there are multiple two-dimensional graphs that can be grouped together. If so, a list is created for the group of two-dimensional graphs and the common X coordinates among the graphs is calculated. Taking the data visualization example (embodiment 300) depicted in FIG. 3 as a reference, the program creates dedicated cell blocks 308 and 309 in the table for the specific graphs-namely, the line graph 301 and the column graph 302. Additionally, the program crafts a separate cell block 307 to accommodate the common X coordinates shared by these graphs. This step is pivotal for organizing and presenting the data in a manner that aligns with the structure of the active chart, thereby enhancing the coherence and utility of the Graph Companion Table in relation to the visualized data.

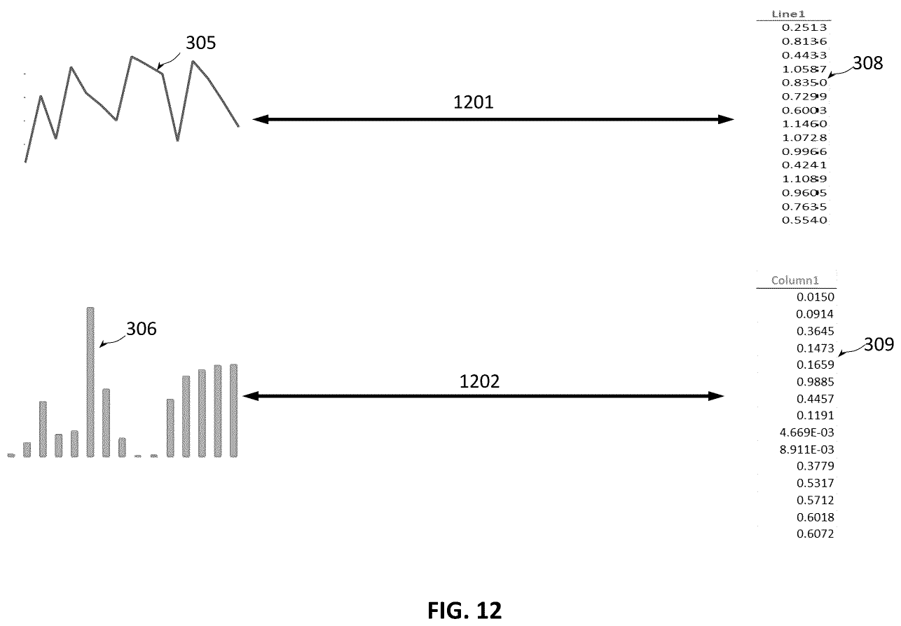

Following creation of the cell blocks, the program adds bidirectional links between each graph and the corresponding cell block in the Graph Companion Table. Block 1106 generally represents this step. As illustrated in FIG. 12 and taking again the data visualization depicted in FIG. 3 as an example, the program creates two bidirectional links: link 1201 between line graph 301 and cell block 306, link 1202 between column graph 302 and cell block 307, respectively.

After cell blocks are added to the Graph Companion Table and links to graphs are established, the program automatically refreshes the display of the table as depicted by block 1108 in FIG. 11. For cell blocks like 308 and 309 in FIG. 1 that are directly linked to graphs, information required for updating the display of each cell in the blocks, such as numerical values and color of the graphical representation, can be fetched directly from the linked graph. For auxiliary cell blocks like 307 in FIG. 3, the required information such as the common X coordinate values of a group of 2D graphs may be saved in a local storage space associated with the cell block.

Once above-described content update of the Graph Companion Table is complete, the program enters an event loop as represented by block 1110 in FIG. 11. In addition to handling standard system events generated by the software platform, the program specifically waits for and handles events related to user interactions with either the graphical visualization or the Graph Companion Table. For example, when a user selects a data point on the graphical display, relevant information, including but not limited to, the graph name and the data point index, is packaged in a message and passed through the bidirectional link to the Graph Companion Table; upon receiving the message, the program maps the graph data point index to the corresponding cell coordinate inside the linked cell block and selects the specific cell accordingly. Conversely, when a user selects a cell inside one of the graph cell blocks inside the Graph Companion Table, a message is sent to the linked graph and the corresponding data point is selected there. Those skilled in the art would appreciate that the same mechanism can be used to synchronize the responses to user interactions between the Graph Companion Table and the linked data visualization other than data selection chiefly by varying format and content of the messages.

Lastly, when the Graph Companion Table is informed of a change in active chart, for example, when the user starts to interact with a chart that is different from the one the Graph Companion Table is associated with, the content of the Graph Companion Table is cleared and links to the graphs in the original chart are removed. The process of creating cell blocks, establishing links, and refreshing display as depicted by blocks 1104, 1106, and 1108 is repeated with data from the new active chart before control of the program eventually goes back to event loop 1110.

While the content discussed has been detailed using terminology specific to computer structure, methods, and computer-readable formats, it should be noted that the invention outlined in the claims attached is not confined to the particular details mentioned. Instead, these details are provided as illustrative examples of how the claims might be realized.

The subject matter outlined above is intended purely for illustrative purposes and should not be seen as restrictive. It is possible to apply various alterations and modifications to the described content without straying from the example embodiments and applications presented, and without deviating from the genuine essence and breadth of the current invention, as delineated in the subsequent claims.

What is claimed is:

1. A method executed by a computer system for implementing an interactive Graph Companion Table to present the underlying data from graphical visualizations within a computing environment, the method comprising:
algorithmically identifying the activation of a specific chart from among a plurality of graphical visualizations, thereby designating it as the active chart;
retrieving the underlying data from a plurality of graphs of various types contained within the active chart;
filling the Graph Companion Table with a plurality of cell blocks of various formats, corresponding to every graph present in the active chart;
establishing bidirectional links between the cell blocks in the Graph Companion Table and their respective graphs in the active chart;
refreshing the display of the Graph Companion Table to reflect any new or modified content, thereby keeping the data presentation current;
responding to user interactions with the active chart and the Graph Companion Table, ensuring that any changes in one are mirrored in the other.

2. The method of claim 1, wherein the active chart is determined based on explicit user selection or interaction, or by system logic identifying the most recently interacted with or generated chart in scenarios lacking direct user input.

3. The method of claim 1, including the steps of employing a predefined algorithm to automatically clear existing cell blocks and their associated bidirectional links upon the detection of a change in the active chart, followed by the creation of new cell blocks and links based on the newly activated chart's data structure.

4. The method of claim 1, further comprising dynamically configuring cell blocks within the Graph Companion Table to synergize with and enhance the graphical representation of data within the active chart, wherein the configuration includes:
grouping cell blocks for multiple two-dimensional graphs together, sharing a common row or column for X-axis values while allocating individual rows or columns for the Y-axis values of each graph's underlying data, with an aggregation of all X-axis values across graphs to accommodate graphs with varying X-axis values and leaving cells corresponding to absent X-axis values in any graph intentionally blank;
creating distinct cell blocks for three-dimensional graphs to display individual data components, including but not limited to X, Y, and Z coordinates, as well as graphical attributes like vertex color and alpha levels;
presenting data of contour graphs with a series of data tables where each table captures all the contour coordinates at a specific contouring level, and the coordinates for contour lines are organized into pairs of rows or columns, with each pair representing a single line, thereby streamlining the visualization of contour data across varying levels;
enabling cell blocks to optionally display coordinates of geometric shapes depicted in the graphical display on the active chart, providing a novel method for visualizing the source data of the graphs or the geometric interpretations of data points; and
implementing a smart configuration system that decides on the optimal arrangement of cell blocks based on the type and dimensions of graphs present in the active chart, including a mechanism for automatically adjusting the layout of cell blocks to best represent the data's structure and relationships within the visualization.

5. The method of claim 1, wherein visual attributes of cell blocks within the Graph Companion Table, such as cell text and background color, are customized to improve alignment with the graphical displays and enhance overall user experience.

6. The method of claim 1, wherein a comprehensive suite of user interactions with the Graph Companion Table and the active chart, such as value editing, data point selection, and graphical marker placement, triggers immediate, synchronized updates across both the table and chart through a real-time data exchange protocol.

7. A computer system comprising:
a processor; and
a computer-readable storage medium having computer-executable instructions stored thereon which, when executed by a computer, cause the apparatus to perform operations comprising:
algorithmically identifying the activation of a specific chart from among a plurality of graphical visualizations, thereby designating it as the active chart;
retrieving the underlying data from a plurality of graphs of various types contained within the active chart;
filling the Graph Companion Table with a plurality of cell blocks of various formats, corresponding to every graph present in the active chart;
establishing bidirectional links between the cell blocks in the Graph Companion Table and their respective graphs in the active chart;
refreshing the display of the Graph Companion Table to reflect any new or modified content, thereby keeping the data presentation current;
responding to user interactions with the active chart and the Graph Companion Table, ensuring that any changes in one are mirrored in the other.

8. The computer system of claim 7, wherein the active chart is determined based on explicit user selection or interaction, or by system logic identifying the most recently interacted with or generated chart in scenarios lacking direct user input.

9. The computer system of claim 7, including the steps of employing a predefined algorithm to automatically clear existing cell blocks and their associated bidirectional links upon the detection of a change in the active chart, followed by the creation of new cell blocks and links based on the newly activated chart's data structure.

10. The computer system of claim 7, further comprising dynamically configuring cell blocks within the Graph Companion Table to synergize with and enhance the graphical representation of data within the active chart, wherein the configuration includes:
grouping cell blocks for multiple two-dimensional graphs together, sharing a common row or column for X-axis values while allocating individual rows or columns for the Y-axis values of each graph's underlying data, with an aggregation of all X-axis values across graphs to accommodate graphs with varying X-axis values and leaving cells corresponding to absent X-axis values in any graph intentionally blank;
creating distinct cell blocks for three-dimensional graphs to display individual data components, including but not limited to X, Y, and Z coordinates, as well as graphical attributes like vertex color and alpha levels;
presenting data of contour graphs with a series of data tables where each table captures all the contour coordinates at a specific contouring level, and the coordinates for contour lines are organized into pairs of rows or columns, with each pair representing a single line, thereby streamlining the visualization of contour data across varying levels;
enabling cell blocks to optionally display coordinates of geometric shapes depicted in the graphical display on the active chart, providing a novel method for visualizing the source data of the graphs or the geometric interpretations of data points; and
implementing a smart configuration system that decides on the optimal arrangement of cell blocks based on the type and dimensions of graphs present in the active chart, including a mechanism for automatically adjusting the layout of cell blocks to best represent the data's structure and relationships within the visualization.

11. The computer system of claim 7, wherein visual attributes of cell blocks within the Graph Companion Table, such as cell text and background color, are customized to improve alignment with the graphical displays and enhance overall user experience.

12. The computer system of claim 1, wherein a comprehensive suite of user interactions with the Graph Companion Table and the active chart, such as value editing, data point selection, and graphical marker placement, triggers immediate, synchronized updates across both the table and chart through a real-time data exchange protocol.
